(19) United States
(12) Patent Application Publication
(10) Pub. No.: US 2014/0279181 A1
(43) Pub. Date: Sep. 18, 2014

(54) BLOOMCUBE

(71) Applicant: Bryan Allen Wills, Suwanee, GA (US)

(72) Inventor: Bryan Allen Wills, Suwanee, GA (US)

(21) Appl. No.: 14/205,525

(22) Filed: Mar. 12, 2014

Related U.S. Application Data
(60) Provisional application No. 61/777,573, filed on Mar. 12, 2013.

(51) Int. Cl. G06Q 30/06; A01G 9/02; G06Q 50/00; A01G 27/00

(52) U.S. Cl. CPC G06Q 30/0621; A01G 27/00; A01G 27/003; A01G 9/02; G06Q 30/0641; G06Q 50/01
USPC 705/26.5; 47/79; 47/65.5

(57) ABSTRACT

A system and method for designing and implementing a garden layout in an online environment is provided. The system comprises an interactive online website, an online application webpage having a graphical workspace for designing the garden layout online and an online merchandising application to purchase a dynamically generated garden layout kit to replicate the virtual design in the real world. Users can obtain free or paid memberships; paid members can receive additional services including a real-time customer service mechanism for providing professional guidance to the plurality of members, access for larger/multiple layouts and additional features. An online community forum associated with the interactive online website allows a plurality of registered users to receive suggestions and feedbacks from other users and experts based on digitally uploaded data. The system can track, share, and manage the content of the containers remotely.

### PRIORITY CLAIM

This application claims priority to co-pending provisional application Ser. No. 61/777,573 filed on Mar. 12, 2013 and is fully incorporated by reference herein.

### TECHNICAL FIELD OF THE EMBODIMENT

The present embodiment relates to a system for designing, planting and harvesting a garden. More specifically, the present embodiment relates to an online system for designing, installing and maintaining a garden, such as a fruit and/or vegetable garden, or a flower bed.

### DESCRIPTION OF THE RELATED ART

Planning and implementing a garden can be very difficult because it requires a number of skills and involves many challenges. One challenge to designing a garden is finding information on the multitude of potential crops, plants or flowers to plant in a garden based on the geography, soil composition, season, and available space. Another challenge is to design and implement a garden with a pleasing aesthetic shape within the available space limits. Another challenge in designing a garden is determining yield, and monetary value estimates for each type of plant/crop planted in a garden of a certain size. These challenges are compounded during the design of the garden as the gardener selects the various plants/crops to plant and changes selections. Determining crop selection to provide maximum yield, nutritional value or monetary value for a certain size garden is challenging based on the lack of information and multitude of choices of crops to plant.

Some garden design applications available in the market can be utilized to design the garden after the selection of plants is made. Existing online/offline garden design sites and applications provide services only for the initial design of the garden. These designs do not incorporate various styles of containers to be used for growing the plants; and these designs may not allow the user to configure a garden layout using a three dimensional grid. Moreover the existing designing systems will not allow users to select from pre-defined designs and templates which were created by other users. Some existing garden design applications do not provide professional advice by referring any growing data to the user.

Conventional design software also comes up short in providing the ability to assist in finding, choosing and purchasing the seeds, containers for growing the plants, and other materials necessary for installing the garden as specified by the design. Another challenge faced by the gardener may be to determine a design for an irrigation system suitable for maintaining the crops. Finally, some gardeners need help to know when to weed or harvest the crops that are not provided in existing design software.

One prior art patent is U.S. Pat. No. 7,162,438 issued to Kelly on Jan. 9, 2007, discloses a method and system for supplying gardening/agricultural information and advice uses an inventory of plant life on a user's property to generate a recommended plant maintenance plan. The method and system may be automated by a computer. The recommended maintenance plan includes recommended gardening materials and a schedule of times or time windows during which the materials should best be applied for all of the various plants. Specific instructions may be supplied to the user in a timely fashion as to when and how to apply various gardening materials, as well as exactly which gardening materials should be applied, to the various types of plant life on the user's property. If the user so chooses, the recommended materials may be automatically sent to the user at the appropriate times and an account of the user may be automatically debited accordingly. But the system does not provide provision for designing the garden layout before installation and do not provide real-time customer service from experts and online community members and fails to provide a properly designed irrigation system to the various plants in the garden.

U.S. Pat. No. 7,167,834 issued to Kelly on Jan. 23, 2007 relates to a garden and agricultural material identification method and apparatus. The method and apparatus identifies an appropriate gardening based on user responses to a plurality of inquiries. Inquiries may include location of the gardening need as well as type of pest. In a preferred embodiment, the method is practiced on an internet site that provides the user with the opportunity to purchase identified gardening materials through the internet. In a preferred embodiment, the gardening materials are identified based on geographic location of the user. The product label is also displayed based on the geographical location of the user. The queries allow the gardener to specify the type of area in which a problem exists, the type of problem, and the geographic location of the problem. Once appropriate user response has been obtained, appropriate garden materials are identified to the user. The problems can relate to pests, fertilizer and seeds. After user responses have been input, the database is searched for an appropriate product based on the user responses. After a list of the appropriate products is presented, the user can see the label. The user is then queried whether they wish to purchase the product. The above said method and apparatus are used for purchasing gardening materials online and do not provide a garden design feature with the online service.

One prior art publication is U.S. Pat. Application No. 20100121669 by Madigan on May 13, 2010, that discloses a system and method for determining how to prepare and maintain lawns and gardens. The system determines how to prepare and maintain lawn and garden plants and comprises a software product wherein a user can input specific plants desired along with key growing and maintenance information. The system then provides to a user customized information to better manage the user's lawn and garden. The system provides customized information including email alerts to remind customers that it is time to prune, time to fertilize, time to check pH, time to cover plants for winter, time to weed, time to place an insecticide, etc. The method is provided for determining how to prepare lawn and garden products by inputting specific plants desired along with key growing and maintenance information into a computer database and provide customized information to the user from the database to better manage the user's lawn and garden based on the input from the user. But the system does not have a shopping facility associated with the software and fails to provide a properly designed irrigation system to the various plants in the garden.

Hence, it can be seen that there is a need for an online garden design application with provision for purchasing containers online. The needed application would provide unique garden setup/assembly instructions, guidance and suggestions based on user location, season and space available using growing data and professional advice. The application would also include an efficient irrigation system for proper watering of the plants in the garden. Moreover the needed application would provide the ability to configure the layout/relationship/contents of the containers online to replicate that virtual design in the real world. Also the needed application would have the ability to track, share, and manage the content of the containers digitally and allow remote management by a real-time customer service mechanism for community guidance and feedback from professionals.

### SUMMARY OF THE INVENTION

The above-mentioned shortcomings, disadvantages and problems are addressed herein which will be understood by reading and understanding the following specification.

A system and method for designing and implementing a garden layout in an online environment is provided. The system comprises an interactive online website, at least one communication channel and a plurality of gardening materials, which can be purchased by a plurality of users. The interactive online website comprises an online application webpage for designing the garden layout online and implementing and managing the garden layout at a physical location. The online application webpage includes a graphical workspace for creating a two dimensional or a three dimensional garden layout, an online merchandising application associated with the interactive online website enables purchasing of gardening materials including containers, plants, irrigation apparatus and accessories. An online community forum associated with the interactive online website allows the plurality of users to receive suggestions and feedbacks from other users and experts. The online community forum is capable of being written to and read by the plurality of members, each of the plurality of members being registered with the online community forum and authenticated by a unique ID and a password. The interactive online website provides guidance and suggestions based on the user location, season and space available for gardening. The interactive online website provides professional advice to the plurality of users by analyzing a plurality of growing data uploaded digitally to the interactive online website. The growing data can be photographs, measurement charts, videos, notes, etc. Also different tiers of memberships having different levels of services are available to the plurality of users. These tiered memberships include free and paid memberships. Paid members can receive additional services including a real-time customer service mechanism for providing professional guidance to the plurality of members, access for larger/multiple layouts and additional features. A professional level membership will allow landscaping companies to manage multiple client installations and provide attractive and accurate reporting data to their clients.

The unique features of the system are the ability to configure the layout/relationship/contents of project containers online and purchase the dynamically generated kit or instructions to replicate that virtual design in the real world. The system has the ability to track, share, and manage the content of the containers digitally and create a unique one-to-one relationship between an object contained in the physical world and its digital representation in a socially networked virtual environment. The system also includes unique feature of remote management and input of a pre-defined physical installation via its digital representation online.

In an embodiment, the user can buy the containers from a local retail shop or through online from a variety of websites. These containers include a unique identifier provided with each of the plurality of containers. The unique identifier identifies specific information regarding the type, size and other details related to each container. The predefined unique identifier for each container purchased from retail stores or from other sites could be redeemed by checking in to the dynamic online website. This data can be selectively posted or shared to the user's online community member page as well as various other social networks. It may also be directly posted to a real-time customer service mechanism for professional and community guidance/feedback.

In another embodiment, the system can be extended to cover other areas like education, science, etc. The application in education includes use in student management process. For example, creating a kit for students to perform some process/learning task that can be tracked, managed, and taught online remotely or via a social network. The application can also be used in science for creating a project and tracking the project through online environment i.e. for example the ability of scientists to create and configure a test project online that can be replicated and setup in various places and tracked remotely to compare the differences in progress.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a schematic of a system for designing and implementing a garden layout;

FIG. 2 illustrates a perspective view of the a graphical workspace of an online application webpage associated with the interactive online website;

FIG. 3 illustrates a perspective view of a plant container assembly in use;

FIG. 4 illustrates a perspective view of a plurality of detached sidewalls and a pair of perforated plates of the plant container assembly;

FIG. 5 illustrates a perspective view of a pair of sidewalls of the plant container assembly in a locked position;

FIG. 6 illustrates a perspective view of a locking mechanism engaged with the pair of sidewalls in the locked position;

FIG. 7 illustrates a perspective view of a plurality of sidewalls with a fourth sidewall sliding in to form a cavity;

FIG. 8 illustrates a perspective view of a pair of perforated plates stacked together to form a fully permeable state;

FIG. 9 illustrates a perspective view of a pair of perforated plates stacked together to form a partial permeable state;

FIG. 10 illustrates a perspective view of the pair of perforated plates stacked together to form a zero permeable state;

FIG. 11 illustrates a perspective view of the plant container assembly with the pair of perforated plates placed at the bottom portion;

FIG. 12 illustrates a perspective view of a self-watering system;

FIG. 13 illustrates a perspective view of the plant container assembly with the self-watering system positioned on the pair of perforated plates placed at the bottom portion;

FIG. 14 illustrates an operational flow chart of a method of assembling a plant container for implementing a garden layout at a physical location in accordance with an aspect of the preferred embodiment of the present invention; and

FIG. 15 illustrates an operational flow chart of a method of designing and implementing a garden layout utilizing the online application webpage in accordance with an aspect of the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

FIG. 1 illustrates a schematic of a system 10 for designing and implementing a garden layout in an online environment. The system 10 for designing and implementing the garden layout comprises an interactive online website 12 hosted by at least one server 14 connected to a plurality of users 16 through at least one communication channel 18. The server 14 enables the plurality of users 16 to access the interactive online website 12 from a variety of locations through the communication channel 18 of a network 20. The communication channel 18 includes a wired and/or a wireless connection, connecting the server 14 to the plurality of users 16. The system 10 provides the plurality of users 16, engaged with the garden design project, the necessary products including gardening materials having at least a project container and real-time customer support services including professional advice and suggestions from the plurality of other users 16 present in an online community group/forum 22 associated with the garden design project.

The interactive online website 12 comprises an online application webpage 24 for designing the garden layout online and implementing and managing the garden layout 40 at a physical location. The online application webpage 24 includes a graphical workspace 26 for creating a two dimensional or a three dimensional garden layout. An online merchandising application 28 associated with the interactive online website 12 enables purchasing of gardening materials including containers, irrigation systems, plants and accessories either directly from within the graphical workspace 24 or from a separate shopping page of the interactive online website 12. An online community forum 22 associated with the interactive online website 12 allows the plurality of users 16 to receive and suggestions and feedbacks from other users and experts. The online community forum 22 is capable of being written to and read by a plurality of members, each of the plurality of members being registered with the online community forum 22 and authenticated by a unique ID and a password. The interactive online website 12 provides guidance and suggestions based on the user location, season and space available for gardening. The system 10 is capable of dynamically generating unique assembly instructions based on the user's garden layout design.

FIG. 2 illustrates a perspective view of a graphical workspace 24 of an online application webpage 24 associated with the interactive online website 12. The online application webpage 24 page has the graphical workspace 26 area either in form of a two dimensional or a three dimensional designing platform. The graphical workspace 26 has horizontal and vertical column bases for placing a plurality of containers 30 virtually on it for obtaining a desired garden layout. This can be accomplished by using a plurality of tools for editing the garden layout within the graphical workspace 26. The online application webpage 24 has a plurality of previously stored templates displayed along with the graphical workspace 26 areas for utilizing the previously designed and stored templates. The user can select the pre-defined templates and can edit those designs to achieve their desired garden layout. Also the online application webpage 24 allows the user to store a plurality of designs, which may be either an edited pre-defined template or a layout designed from scratch i.e. from the beginning, for further use. The online application webpage 24 also enables the user to access a purchasing inventory while working with the graphical workspace 26. The user can directly order or purchase the containers 30 from the purchasing inventory and plants from the plant inventory. The user can specify the size of the physical available space for implementing the garden layout, based on this the online application webpage 24 automatically adjusts the height and width of the graphical workspace 26.

The interactive online website 12 provides professional advice to the plurality users 16 by analyzing a plurality of growing data, the plurality of growing data being uploaded digitally to the interactive online website 12 by the user. The digital growing data can be photographs, measurement charts, videos, notes and any data related to the garden layout. The interactive online website 12 of the system 10 provides different tiers of memberships having different levels of services to the plurality of users 16. These memberships include free and paid memberships. Paid members can receive additional services including a real-time customer service mechanism for giving professional guidance to the plurality of members, access for larger/multiple layouts and additional features. A professional level membership will allow landscaping companies to manage multiple client installations and provide attractive and accurate reporting data to their clients. The unique features of the system 10 are the ability to configure the layout/relationship/contents of containers online and purchase the dynamically generated kit or instructions to replicate that virtual design in the real world. The ability of the system 10 to track, share, and manage the content of the containers digitally and create a unique one-to-one relationship between an object contained in the physical world and its digital representation in a socially networked virtual environment. The system 10 also includes unique feature of remote management and input of a pre-defined physical installation via its digital representation online.

FIG. 3 illustrates a perspective view of a plant container assembly 40 in use. The plant container assembly 40 for installing in a garden layout comprises a plurality of detachable sidewalls 42, a pair of perforated plates (not shown), a self-watering system 44 having an extruded top portion 46 with a hollow interior and a perforated base portion (not shown). The plurality of sidewalls 42 are attached together to form a cavity having a desired shape, preferably rectangular shape. The pair of perforated plates (not shown) forms a base of the cavity and the self-watering system 44 is placed on this base, within the cavity. For planting a desired garden plant 48 a suitable soil type is selected based on the season, location of the garden, geographical area etc. Soil suitable for growing the desired garden plant 48 is filled inside the cavity and the garden plant 48 is placed in the soil 50 for growing. The self-watering system 44 ensures proper water distribution and moisture content to the soil 50. Water can be poured in through the hollow portion of the extruded top 46 of the self-watering system. The plant container assembly 40 has provision for including a plurality of electronic enhancements comprising heated cube warmer and Wi-Fi/radio frequency identification (RFID) controller for continuously monitoring growth data of the plant.

FIG. 4 illustrates a perspective view of the plurality of detached sidewalls 42 and a pair of perforated plates 52 of the plant container assembly 40. Each of the individual sidewalls 54 is an isometric mirror image of the other sidewall 54 panels. Each of the plurality of sidewalls 42 have an interior side 54, an exterior side (not shown), a top edge 56, a bottom edge 58, a left edge 60 and a right edge 62. The plurality of sidewalls 42, each have a locking channel 64 provided on the left edge 60 and the right edge 62. The locking channel 64 is a groove provided on the left and right edges, along the plurality of sidewalls 42. A first groove on each of the sidewall 42 is extending only on the interior side 54 and a second groove on an opposite edge of the sidewall 42 has the locking channel 64 groove provided on both sides of the sidewall 42. The bottom edge 58 of the plurality of sidewalls 42 has projections, allowing for offset stacking of similar containers and also has gaps at the bottom edge 58 of the plurality of sidewalls 42 allowing for vertical stacking of the containers. The pair of perforated plates 52 is provided with a plurality of holes 66 which are aligned horizontally and vertically preferably at equal distances. The perforated plates 52 can be used in single or in pairs, stacked one above other, for creating a solid base portion for the container. The plurality of holes 66 can have different types of shapes including circular, oval etc. for making different configurations. These different configurations provide different amounts of water permeability though the base formed by the pair of perforated plates 52, when stacked above one another.

FIG. 5 illustrates a perspective view of the pair of sidewalls 42 of the plant container assembly 40 in a locked position. These pair of sidewalls 42 form the part of a rectangular shaped plant container assembly 40. The pair of sidewalls 42 is joined together by sliding a groove or the locking channel 64 of a sidewall through the groove 64 on another sidewall. Each of the plurality of sidewalls 42 has a pair of beveled corners 68 at the bottom edge 58. The two sidewalls 42 when joined together the beveled corners 68 of adjacent sidewalls form a miter joint. Each of the beveled corners 68 of each of the plurality of sidewalls 42 are provided with a slot 70. The slot 70 is provided for locking and securing the miter joint by placing a locking means (not shown) at the slot 70.

FIG. 6 illustrates perspective view of the locking means 72 engaged with the pair of sidewalls 42 in the locked position. The locking means 72 is placed in the slots 70 available at the beveled corners 68 of the plurality of sidewalls 42. The beveled corner 68 with the locking means 72 forms the miter joint. The locking means 72 can be a manufactured slug made from different types of material and can have different shapes including rectangular, oval, circular etc. The manufactured slug should fit into the slots 70 available at the beveled corners 68 of each of the plurality of sidewalls 42 to form a zero hardware locking mechanism.

FIG. 7 illustrates a perspective view of the plurality of sidewalls 42 with a fourth sidewall sliding in to form a rectangular cavity inside. Each of the plurality of sidewalls 42 has a projected or stepped bottom portion at the bottom edge 58. The pair of perforated plates 52 by stacked together or in single, can be securely placed on the projected or stepped portion provided near the bottom edge 58 of the cavity. The base of the self-watering system 44 is placed on the perforated plates 52. The soil for planting the garden plant is poured into the cavity above this self-watering system 44. The perforated plates 52 placed at the stepped bottom portion of the cavity acts as supporting base for supporting the self-watering system 44 and the soil deposited while planting.

FIG. 8 illustrates perspective view of the pair of perforated plates 52 stacked together to form a fully permeable state at the bottom edge 58 of the plant container assembly 40. When the pair of perforated plates 52 is arranged such that the plurality of holes 66 of top and bottom plates perfectly aligns with each other, the arrangement forms a fully permeable state. In this state excess water poured into the container through the self watering system 44 will be automatically drained out easily. This configuration also ensures maximum aeration to the soil at the bottom of the cavity of the plant container assembly 40. The plurality of holes 66 is aligned at equal distances from a first edge and a second edge of the each of the perforated plates 52 and aligned more towards a third edge of the each of the perforated plates 52 than the opposite fourth edge. This will help achieving three configurations for the pair of perforated plates 52 for placing it inside the cavity of the plant container assembly 40.

FIG. 9 illustrates perspective view of the pair of perforated plates 52 stacked together to form a partial permeable state at the bottom edge 58 of the plant container assembly 40. When the pair of perforated plates 52 is arranged in such a way that the plurality of holes 66 of top and bottom plates aligns with each other, only a partial permeability is allowed for excess water as size of the plurality of holes 66 having oval shape is reduced by the alignment. In this state excess water poured into the container through the self watering system 44 will be automatically drained out, but at a lower flow rate compared to the fully permeable configuration shown in FIG. 8. This configuration is achieved by rotating any one of the pair of perforated plates 52 rotated by 90 degrees from the configuration shown in FIG. 8 and stacked together.

FIG. 10 illustrates a perspective view of the pair of perforated plates 52 stacked together to form a zero permeable state. The pair of perforated plates 52 is made from non-corrosive materials. When the pair of perforated plates 52 is arranged in such a way that the plurality of holes 66 of top and bottom plates completely de-aligns with each other, no permeability is allowed for excess water as the plurality of holes 66 having oval shape are blocked by the alignment. In this state excess water poured into the container through the self watering system 44 will not be automatically drained out. This configuration is achieved by rotating any one of the pair of perforated plates 52 rotated by 90 degrees from the configuration shown in FIG. 9, or by rotating 180 degrees from the configuration shown in FIG. 8, and stacked together.

FIG. 11 illustrates a perspective view of the plant container assembly 40 with the pair of perforated plates 52 stacked and placed at the bottom portion of the cavity. The pair of perforated plates 52 is normally of rectangular shape and made of non-corrosive material preferably plastic. These perforated plates 52 are placed on the stepped bottom portion at the bottom edge 58 of the plant container assembly 40. The pair of perforated plates 52 has sufficient strength to carry and withstand the weight of soil and the self-watering system 44 without fail. Also the pair of perforated plates 52 can be of any shape, defined by the shape of the cavity of the plant container assembly 40. The user can decide which type of configuration is required for the pair of perforated plates 52 for obtaining optimal efficiency for growing the plant.

FIG. 12 illustrates a perspective view of a self-watering system 44. The self-watering system 44 has the extruded top portion 46 with a hollow interior 74 and the perforated base portion 76. The perforated base portion 76 has the same shape as the cavity formed within the plant container assembly 40 for properly placing the self-watering system 44. The water poured at the hollow interior 74 of the extruded top portion 46 flows down to reach the perforated base portion 76. A plurality of holes 78 on the surface of the perforated base portion 76 ensures proper spreading of the water around the root of the plant throughout the soil. The perforated base portion 76 of the self-watering system 44 has a plurality of circular perforated segments 80 for increasing the moisture content around the root of the plant placed in the plant container assembly 40. The plurality of circular perforated segments 80 are carved into the perforated base portion 76, centrally downwards from the perforated base portion 76.

FIG. 13 illustrates a perspective view of the plant container assembly 40 with the self-watering system 44 positioned on the pair of perforated plates 52 placed inside the cavity. The plant container assembly 40 has the extruded top portion 46 of the self-watering system 44 positioned within the cavity, the extruded top portion 46 is aligned near the corner formed by the pair of sidewalls 42 of the plant container assembly 44. The continuous elongated channel or the hollow interior 74 extends from the perforated base portion 76 to the top edge 56 of the detachable sidewall 42. The self-watering system 44 is detachable from the cavity. The plurality of circular perforated segments 80 can have various shapes including rectangular, cylindrical etc. These shapes carved into the perforated base portion 76 provides more room for the main root of the plant to grow downwards and can collect more water, as the plurality of circular perforated segments 80 has the maximum moisture and have maximum aeration. This helps in plant growth and can aerate the soil evenly. The excess water poured into the self-watering system 44 is automatically drained out through the plurality of holes 78 on the surface of the perforated base portion 76 and through the carved circular perforated segments. The water flows out through the pair of perforated plates 52.

In an embodiment, the interactive online website 12 enables the customer to buy the containers from a local retail shop or online from a variety of other sites. These containers will be available in various styles to allow users to configure unique project container designs and patterns, track their progress digitally, and allow others to contribute remotely. These containers include a unique identifier provided with each of the plurality of containers. The unique identifier can be a quick response (QR) code carrying information regarding the type, size and other details related to the containers. A mobile device app will allow the user to snap the identifier i.e. the QR code of a given container and see a history of the evolution of its contents and add more related content including photos, videos, notes, etc. This data can be selectively posted or shared to the user's online community member page as well as various other social networks. It may also be directly posted to a real-time customer service mechanism for professional and community guidance/feedback. The user checks-in to the dynamic online website 12 by providing the check-in code. The predefined unique identifier or quick response code of the containers purchased from retail stores or from other sites would have that could be redeemed by checking in to the dynamic online website, allowing the contents to be tracked as above.

In another embodiment, the system 10 includes other potential applications of this process. This system 10 can be used with a variety of process and can be extended to cover other areas like education, science etc. The application in education includes use in student management process. For example, creating a kit for students to perform some process/learning task that can be tracked, managed, and taught online remotely or via a social network. The application can also be used in science for creating a project and tracking the project through online environment. i.e. for example the ability of scientists to create/configure a test project online that can be replicated and setup in various places and tracked remotely to compare the differences in progress.

FIG. 14 illustrates the operational flow chart of a method of assembling a plant container 40 for implementing a garden layout at a physical location in accordance with the aspect of the preferred embodiment of the present invention. The method includes the steps of bringing together a plurality of sidewalls, a pair of perforated plates, a self watering system and a pair of locking means as indicated at block 100. The plurality of sidewalls locked each other, by sliding and engaging a pair of lockable grooves provided on a pair of opposite edges, to form a cavity inside as shown in block 102. Then the plurality of sidewalls are secured by engaging the pair of locking means to a slit cut at a bottom corner of each of the plurality of sidewalls as indicated at block 104. Now the pair of perforated plates is placing on a bottom portion of the cavity by sliding through within the cavity as indicated at block 106. Thereafter, the self watering system is positioned within the cavity with a base of the self watering system placed on the pair of perforated plates as shown in block 108. After completing above said steps, a selected type of soil which is selected by a user is filled inside the cavity as shown in block 110 and a suitable plant selected by the user can be planted in the selected type of soil as indicated at block 112.

FIG. 15 illustrates the operational flow chart of a method of designing and implementing a garden layout utilizing an online application webpage in accordance with the aspect of the preferred embodiment of the present invention. The method includes the steps of visiting a dynamic website offering a garden layout design and implementing service by a user utilizing a web browser in a computer network in an online environment as indicated at block 114. The user can now browse through the dynamic website to select a particular type of service as shown by block 116. Now the user may join with an online community forum associated with the dynamic website as indicated at block 118. Then opening a graphical interactive workspace within the online application webpage as shown by block 120. A plant container can be selected from a plurality of plant container designs provided within the online application webpage as indicated at block 122. Then the user will b able to design a two dimensional and/or a three dimensional garden layout on the graphical interactive workspace utilizing a plurality of tools provided with the application as shown by block 124. Next the user may finalize a designed layout of the desired garden pattern as indicated at block 126. The user can order at least one plant container through an online shopping facility provided within the dynamic website as indicated at block 128 and a physical garden installation at a desired location can be implemented by the user based on the garden layout from the online application webpage as shown in block 130. Block 132 shows the step of uploading a plurality of data of each plant of the garden by the user to the online community forum and block 134 shows the step of receiving professional advice from experts and a plurality of members of the online community forum whenever the user is requested.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, a wide range of containers may be obtained by varying the shapes of the sidewalls and a wide range of electronic enhancements or electronic measurement devices related to gardening can be employed. This system can also be extended to other areas like education, science, music and entertainment, online shopping etc. It is intended that the scope of the present invention not be limited by this detailed description, but by the claims and the equivalents to the claims appended hereto.

Other embodiments are within the claims. The preceding recitation is provided as an example of the preferred embodiment and an alternate embodiment for illustrative purposes and is not meant to limit the nature or scope of the present appended claims. Variations of the invention are anticipated by those skilled in the art.

I claim:

1. A plant container assembly for use with a garden layout comprising:
a plurality of detachable sidewalls, each having an interior side, an exterior side, atop edge, a bottom edge, a left edge and a right edge, defining a cavity inside;
a pair of perforated bottom plates stacked together at a bottom portion of the cavity; and
a self-watering system having an extruded top portion with hollow interior and a perforated base portion;
whereby the plant container assembly formed by assembling the plurality of detachable sidewalls can be stacked together to form a desired garden layout.

2. The plant container assembly of claim 1 wherein the bottom portion of the cavity formed by the plurality of sidewalls are stackable, the plurality of detachable sidewalls has a plurality of projections and gaps at a bottom portion to allow for offset stacking and/or vertical stacking.

3. The plant container assembly of claim 1 wherein the bottom portion of the cavity has provision for including a plurality of electronic enhancements comprising heated cube warmer and Wi-Fi/radio frequency identification (RFID) controller for continuously monitoring growth data of the plant.

4. The plant container assembly of claim 1 wherein the left edge and the right edge of the plurality of detachable sidewalls has a slot provided on each corner of the bottom edge for creating a locking mechanism employing a manufactured slug.

5. A method of designing and implementing a garden layout utilizing an online application webpage comprising the steps of:
a) visiting a dynamic website offering a garden layout design and implementing service by a user utilizing a web browser in a computer network in an online environment;
b) browsing through the dynamic website by the user to select a particular type of service;
c) joining the user with an online community forum associated with the dynamic website;
d) opening a graphical interactive workspace within the online application;
e) selecting a plant container from a plurality of plant container designs provided within the online application;
f) designing a two dimensional and/or a three dimensional garden layout on the graphical interactive workspace utilizing a plurality of tools provided with the application;
g) finalizing a designed layout of the desired garden pattern by the user;
h) ordering at least one plant container through an online shopping facility provided within the dynamic website;
i) implementing a physical garden installation at a desired location by the user based on the garden layout from the online application;
j) uploading a plurality of data of each plant in the garden by the user to the online community forum; and
k) receiving professional advice from experts and a plurality of members of the online community forum.

6. The method of claim 5 wherein the user can create a personal account within the dynamic website, the user having the personal account can join the online community forum to become a member.

7. The method of claim 5 wherein the dynamic website offers real-time customer service mechanism to the plurality of users from experts and the plurality of members of the online community forum.

8. The method of claim 5 wherein the dynamic website offers different tiers of memberships for the plurality of users offering different levels of services, different tiers of memberships includes free and paid memberships.

9. The method of claim 5 wherein the online application webpage allows the user to use a plurality of pre-designed garden templates available within the online application.

10. The method of claim 5 wherein the online application webpage allows the user to design and store a plurality of new garden layouts within the personal account of the user.

11. The method of claim 5 wherein the plant containers can be ordered from at least one of different services including the online shopping facility of the dynamic website, a retail store and/or from a plurality of other websites offering online shopping facility.

12. The method of claim 5 wherein each of the plurality of plant container includes a unique identifier code, the unique identifier code can be redeemed on the dynamic website for tracking online.

13. The method of claim 5 wherein the user can upload the plurality of data of each plant of the garden by specifying the unique identifier code of the corresponding of the plant container, the plurality of data includes the plurality of growth details in digital form including notes, video and pictures.

14. The method of claim 5 wherein the user can receive a real-time customer service from experts and the plurality of members of the online community forum for the design, implementation and management of the garden.

15. The method of claim 5 wherein the dynamic website enables the user to have ability to track, share, and manage content of the plurality of plant containers digitally and create a unique one-to-one relationship between an object contained in the physical world and a digital representation of the object in a socially networked online environment.

16. The method of claim 5 wherein the dynamic website enables remote management and input of a pre-defined physical installation via a digital representation of the pre-defined physical installation online.

17. A container assembly comprising:
a plurality of detachable isometric sidewalls, each having an interior side, an exterior side, a top edge, a bottom edge, a left edge and a right edge;
at least one bottom plate;
whereby the container assembly formed by assembling the plurality of detachable isometric sidewalls and bottom plate form a cavity.

18. The container assembly of claim 17 wherein the bottom plate of the cavity formed by the plurality of isometric sidewalls are stackable, the plurality of detachable isometric sidewalls has a plurality of projections and gaps at a bottom portion to allow for offset stacking and/or vertical stacking.

19. The container assembly of claim 17 wherein the bottom edge of the detachable isometric sidewalls is configured to fit inside the cavity of an assembled container so the containers can be stacked.

20. The container assembly of claim 17 wherein the left edge and the right edge of the plurality of detachable isometric sidewalls has a slot provided on each corner of the bottom edge for creating a locking mechanism employing a manufactured slug.
